(19) United States
(12) Patent Application Publication
(10) Pub. No.: US 2019/0311838 A1
(43) Pub. Date: Oct. 10, 2019

(54) MULTIPHASE TRANSFORMER

(71) Applicant: FANUC CORPORATION, Yamanashi (JP)

(72) Inventor: Shouhei Kobayashi, Yamanashi (JP)

(73) Assignee: FANUC CORPORATION, Yamanashi (JP)

(21) Appl. No.: 16/375,992

(22) Filed: Apr. 5, 2019

(30) Foreign Application Priority Data
Apr. 9, 2018 (JP) 2018-074975

(51) Int. Cl. H01F 27/28; H01F 27/24

(52) U.S. Cl. CPC H01F 27/28; H01F 27/24

(57) ABSTRACT

A multiphase transformer according to the present disclosure includes a peripheral iron core, at least six leg iron cores arranged on an inner surface of the peripheral iron core at established intervals in a circumferential direction, and coils each wound on each of the at least six leg iron cores. Each of the at least six leg iron cores is arranged such that one end in the direction of a winding axis of the coil is magnetically connected to the peripheral iron core, and the other end in the direction of the winding axis is magnetically connected to the other end of another leg iron core of the at least six leg iron cores. The at least six coils are assigned to individual phases of the multiphase transformer in twos or more.

### BACKGROUND OF THE INVENTION

### 1. Field of the Invention

The present invention relates to a multiphase transformer, and more specifically relates to a multiphase transformer having a plurality of coils.

### 2. Description of Related Art

In general, three-phase transformers each have three iron cores and three coils wound on the iron cores. Japanese Unexamined Patent Publication (Kokai) No. 2013-529393 discloses an integrated magnetic device in which three magnetic subassemblies are arranged in a triangular form.

### SUMMARY OF THE INVENTION

Conventional multiphase transformers have the problems that it is difficult to miniaturize the multiphase transformers, since a reduction in the number of turns of coils causes an increase in inrush current at turning on the transformer.

A multiphase transformer according to the present disclosure includes a peripheral iron core, at least six leg iron cores arranged on an inner surface side of the peripheral iron core at established intervals in a circumferential direction, and coils each wound on each of the at least six leg iron cores. Each of the at least six leg iron cores is arranged such that one end in the direction of a winding axis of the coil is magnetically connected to the peripheral iron core, and the other end in the direction of the winding axis is magnetically connected to the other end of another leg iron core of the at least six leg iron cores. The at least six coils are assigned to individual phases of the multiphase transformer in twos or more.

### BRIEF DESCRIPTION OF THE DRAWINGS

The objects, features, and advantages of the present invention will be more apparent from the following description of embodiments relating to the drawings. In the drawings:

FIG. 1 is a plan view of a three-phase transformer having three poles;

FIG. 2 is a graph illustrating time variations in inrush current flowing through a multiphase transformer at turn-on, before and after a reduction in the number of turns of the multiphase transformer;

FIG. 3 is a plan view of a multiphase transformer having six poles according to a first embodiment;

FIG. 4 is a configuration diagram of a general magnetic circuit;

FIG. 5 is a plan view of a multiphase transformer having twelve poles according to the first embodiment;

FIG. 6 is a graph illustrating a time variation in input voltage to a multiphase transformer according to the first embodiment;

FIG. 7 illustrates distribution diagrams of magnetic fields formed when alternating voltage is applied to multiphase transformers according to the first embodiment; and

FIG. 8 is a perspective view of a multiphase transformer according to a second embodiment.

### DETAILED DESCRIPTION OF THE INVENTION

A multiphase transformer according to the present invention will be described below with reference to the drawings. However, the technical scope of the present invention is not limited to its embodiments, but extends to the invention described in the scope of claims and equivalents thereof.

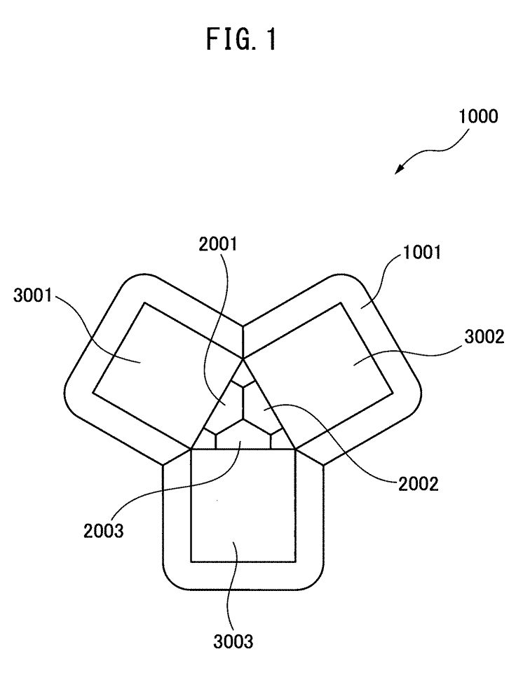

Referring to FIG. 1, a conventional three-phase transformer having three poles will be first described. A conventional three-phase transformer 1000 includes a peripheral iron core 1001, three leg iron cores 2001 to 2003, and coils 3001 to 3003 wound on the leg iron cores 2001 to 2003, respectively. For example, the coils 3001 to 3003 may be an R-phase coil, an S-phase coil, and a T-phase coil, respectively.

To miniaturize the multiphase transformer, a method of reducing the number of turns of the coils is conceivable. However, there is a problem that simply reducing the number of turns of the coils causes an increase in inrush current at turning on the multiphase transformer. This problem will be described below.

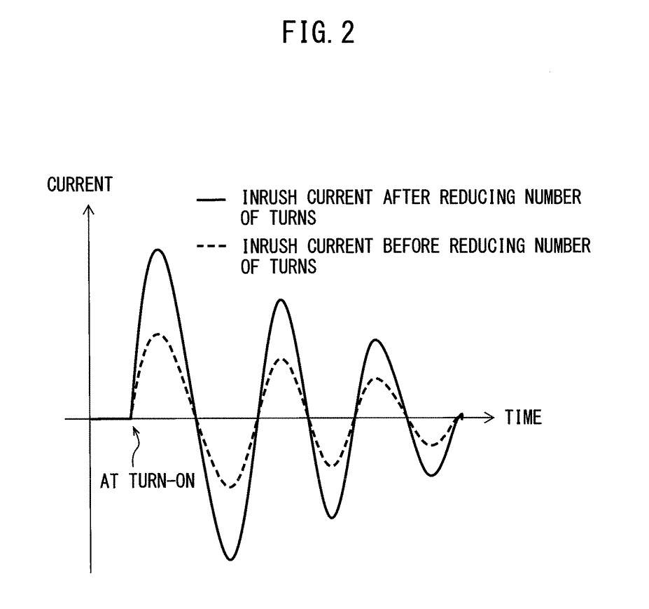

FIG. 2 is a graph illustrating time variations in inrush current flowing through the multiphase transformer at turn-on, before and after a reduction in the number of turns of the multiphase transformer. In FIG. 2, a broken line represents the inrush current before the reduction in the number of turns, and a solid line represents the inrush current after the reduction in the number of turns. As illustrated in FIG. 2, since the reduction in the number of turns causes an increase in the inrush current, there is a problem that the method of simply reducing the number of turns cannot contribute to miniaturization of the multiphase transformer.

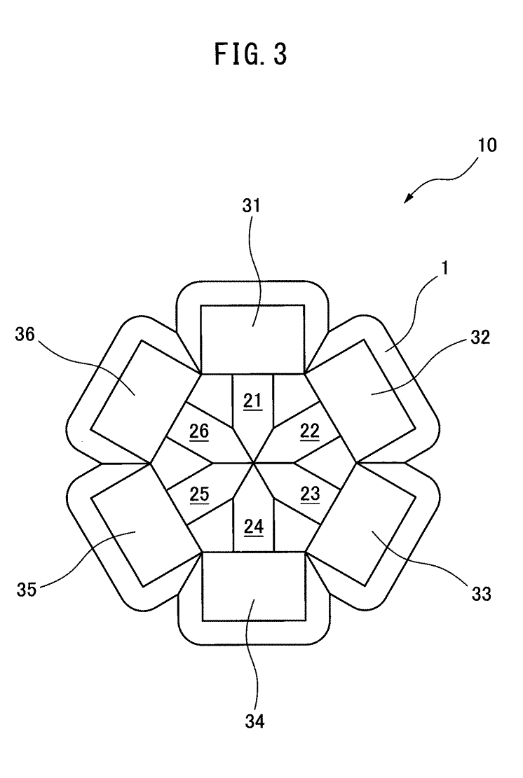

FIG. 3 is a plan view of a multiphase transformer having six poles according to a first embodiment. A multiphase transformer 10 according to the first embodiment includes a peripheral iron core 1, six leg iron cores 21 to 26 arranged on an inner surface side of the peripheral iron core 1 at established intervals in a circumferential direction, and coils 31 to 36 wound on the six leg iron cores 21 to 26, respectively. The peripheral iron core 1 illustrated in FIG. 3 may be constituted of a plurality of peripheral iron core portions.

Each of the six leg iron cores 21 to 26 is arranged such that one end in the direction of a winding axis of each of the coils 31 to 36 is magnetically connected to the peripheral iron core 1, and the other end in the direction of the winding axis is magnetically connected to the other end of another leg iron core of the six leg iron cores 21 to 26.

The six coils 31 to 36 are assigned to individual phases of the multiphase transformer 10 in twos or more. For example, the coils 31 and 32 may be assigned to an R-phase of the multiphase transformer 10. The coils 33 and 34 may be assigned to an S-phase of the multiphase transformer 10. Furthermore, the coils 35 and 36 may be assigned to a T-phase of the multiphase transformer 10.

The six leg iron cores 21 to 26 are preferably configured such that the larger the number of leg iron cores, the shorter magnetic paths are formed in the leg iron cores of each phase. Taking multiphase transformer having six leg iron cores as an example, magnetic path length is configured to be shorter than that of multiphase transformer having three leg iron cores. By way of example, provided that multiphase transformers have a constant magnetic flux density (e.g. 1.65 [T]) and a constant voltage drop (e.g. 87 [V]), if a multiphase transformer having three leg iron cores has a magnetic path length of 751 mm, a multiphase transformer having six leg iron cores has a magnetic path length of 450 mm, i.e., reduced by approximately 40%.

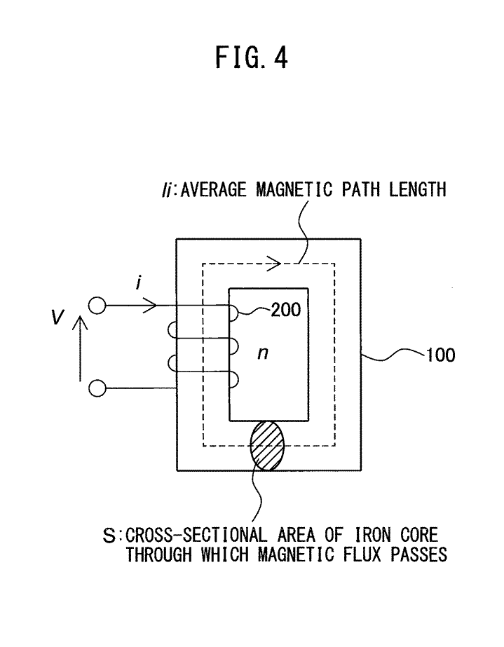

The miniaturization of multiphase transformers as result of reduction in magnetic path length will be described. FIG. 4 is a configuration diagram of a general magnetic circuit. In the magnetic circuit of FIG. 4, a coil 200 is wound n turns on an iron core 100. A voltage V is applied to the coil 200, and a current i flows through the coil 200. The average magnetic path length of the iron core 100 is represented by lᵢ, and the cross-sectional area of the iron core through which magnetic flux passes is represented by S. At this time, a magnetic resistance Rₘ is calculated by the following equation (1).

Rₘ=lᵢ/(μᵣμₒS) (1)

wherein, μᵣ is a relative magnetic permeability, and μₒ is a magnetic permeability in a vacuum. The cross-sectional area S is constant.

An inductance L is calculated by the following equation (2).

L=n²/Rₘ (2)

According to the equation (1), the magnetic resistance Rₘ decreases as the magnetic path length lᵢ decreases. According to the equation (2), the inductance L increases as the magnetic resistance Rₘ decreases.

An increase in the inductance L can reduce an inrush current flowing through a multiphase transformer. According to the equation (2), when the inductance L is kept constant, the number n of turns can be reduced by a decrease in the magnetic resistance Rₘ.

By way of example, a transformer of three-pole structure has primary coils of 204 turns and secondary coils of 170 turns. In this case, as a result of adjusting the numbers of turns while an inrush current is kept at the same level (192 [A]), a transformer of six-pole structure, i.e., the multiphase transformer according to the first embodiment has primary coils of 185 turns and secondary coils of 154 turns, thus enabling a reduction in the number of turns by the order of 10%. As a result of this, the transformer of six-pole structure, i.e., the multiphase transformer according to the first embodiment can be miniaturized 0.6 times in volume and 0.8 times in weight, as compared with the transformer of three-pole structure.

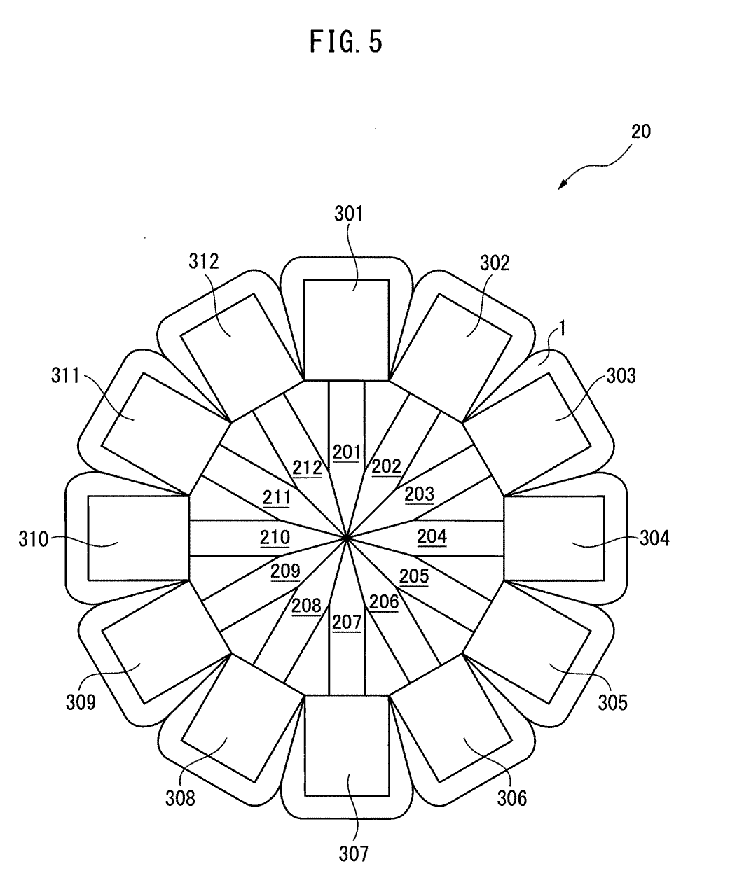

In the same manner, an increase in the number of poles from six-pole structure to twelve-pole structure, in other words, an increase in the number of leg iron cores can contribute to miniaturization of a multiphase transformer. FIG. 5 is a plan view of a multiphase transformer having twelve poles according to a modification example of the first embodiment. A multiphase transformer 20 according to the modification example of the first embodiment includes a peripheral iron core 1, twelve leg iron cores 201 to 212 arranged on an inner surface side of the peripheral iron core 1 at established intervals in a circumferential direction, and coils 301 to 312 wound on the twelve leg iron cores 201 to 212, respectively.

Each of the twelve leg iron cores 201 to 212 is arranged such that one end in the direction of a winding axis of the coil is magnetically connected to the peripheral iron core 1, and the other end in the direction of the winding axis is magnetically connected to the other end of another leg iron core of the twelve leg iron cores. For example, one leg iron core 201 of the twelve leg iron cores 201 to 212 contacts another leg iron core 202 adjoining to the one leg iron core 201.

The twelve coils 301 to 312 are assigned to individual phases of the multiphase transformer 20 in twos or more. For example, the coils 301 to 304 may be assigned to an R-phase of the multiphase transformer 20. The coils 305 to 308 may be assigned to an S-phase of the multiphase transformer 20. Furthermore, the coils 309 to 312 may be assigned to a T-phase of the multiphase transformer 20.

The twelve leg iron cores 201 to 212 are preferably configured such that the larger the number of leg iron cores, the shorter magnetic paths are formed in the leg iron cores of each phase. Taking multiphase transformer having twelve leg iron cores as an example, magnetic path length is configured to be shorter than that of multiphase transformer having six leg iron cores.

As described above, a reduction in magnetic path length allows a reduction in the number of turns. As a result, the multiphase transformers have reduced weights and reduced installation areas, and can therefore be miniaturized.

As described above, the multiphase transformers having the six leg iron cores and the twelve leg iron cores are described as examples, but not limited to these examples, the number of at least six leg iron cores is preferably an integral multiple of 3. Accordingly, an odd number, such as 9, 15 or 21, of coils may be provided, or an even number, such as 18 or 24, of coils may be provided. However, when coils arranged in opposite positions of a multiphase transformer are assigned to the same phase, the multiphase transformer preferably has a symmetrical arrangement. In such a case, the number of at least six coils is preferably an integral multiple of 6.

Then, assignments of coils to individual phases of a multiphase transformer will be described. More specifically, the relationship between arrangements of coils to individual phases and a magnetic path length in a multiphase transformer will be described.

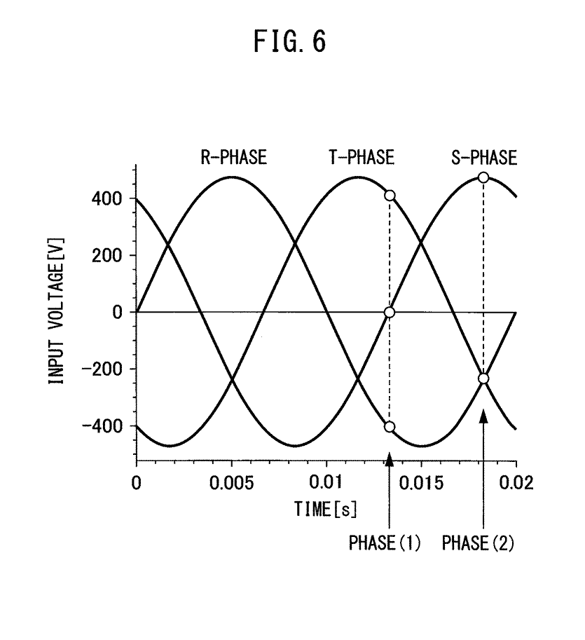

The variation of a magnetic path length of a multiphase transformer in accordance with the phase of alternating voltage applied to the multiphase transformer will be first described. FIG. 6 is a graph illustrating a time variation in input voltage to a multiphase transformer according to the first embodiment. By way of example, a phase (1) represents a phase in which an input voltage to an S-phase becomes 0 [V], and a phase (2) represents a phase in which the input voltage to the S-phase is maximized.

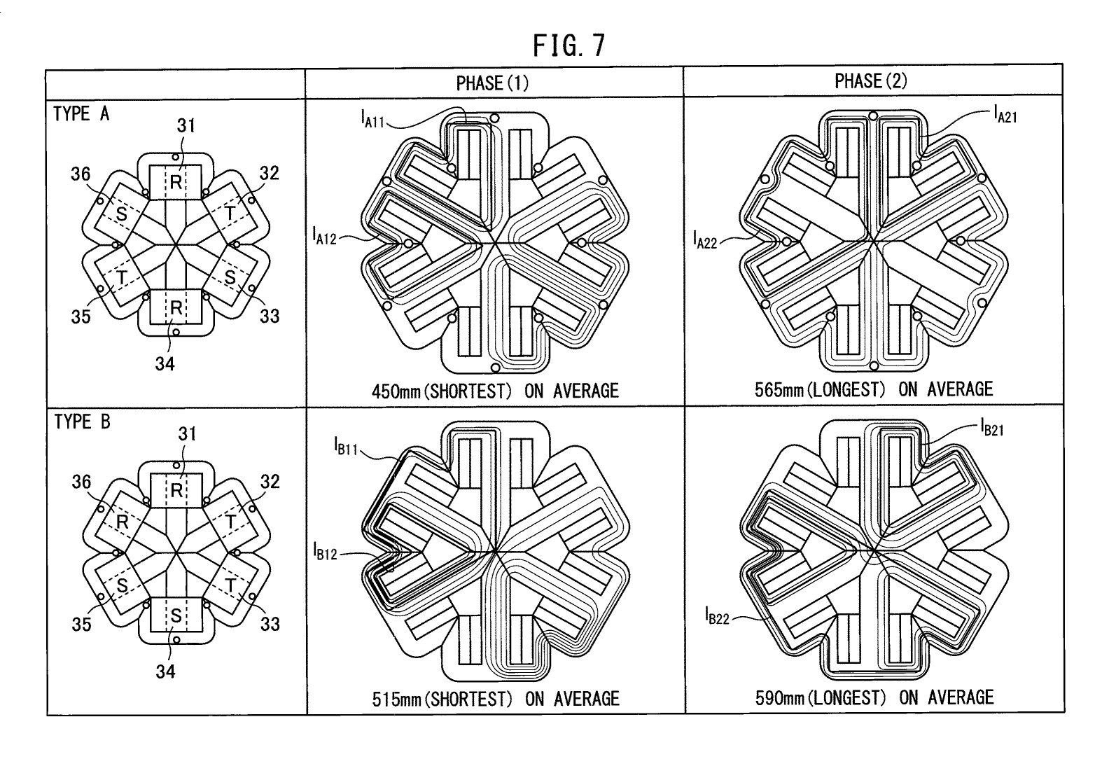

FIG. 7 illustrates distribution diagrams of magnetic fields formed when the alternating voltage is applied to multiphase transformers according to the first embodiment. In an arrangement of “type A”, two opposite coils with respect to the center of a peripheral iron core are assigned to the same phase. To be more specific, as illustrated in an upper row of FIG. 7, type A refers to an arrangement in which coils 31 and 34 are assigned as R-phase coils, coils 33 and 36 are assigned as S-phase coils, and coils 32 and 35 are assigned as T-phase coils.

In an arrangement of “type B”, one coil of at least six coils is assigned to the same phase as another adjoining coil. To be more specific, as illustrated in a lower row of FIG. 7, type B refers to an arrangement in which coils 31 and 36 are assigned as R-phase coils, coils 34 and 35 are assigned as S-phase coils, and coils 32 and 33 are assigned as T-phase coils.

In the type A, two magnetic paths are formed in the phase (1). When l_{A11} and l_{A12} represent the magnetic paths, an average magnetic path length (l_{A11}+l_{A12})/2 is calculated at 450 mm. On the other hand, in the same type A, two magnetic paths are formed in the phase (2). When l_{A21} and l_{A22} represent the magnetic paths, an average magnetic path length (l_{A21}+l_{A22})/2 is calculated at 565 mm.

On the contrary, in the type B, two magnetic paths are formed in the phase (1). When l_{B11} and l_{B12} represent the magnetic paths, an average magnetic path length (l_{B11}+l_{B12})/2 is calculated at 515 mm. On the other hand, in the same type B, two magnetic paths are formed in the phase (2). When l_{B21} and l_{B22} represent the magnetic paths, an average magnetic path length (l_{B21}+l_{B22})/2 is calculated at 590 mm. Therefore, diagonally arranging the coils of the same phase, such as the type A, allows a reduction in the magnetic path length to 87% to 95%, with respect to the case of arranging the coils of the same phase side by side, such as the type B.

As described above, it is found out that the magnetic path length depends on how to assign the coils to the individual phases of the multiphase transformer. It is also found out that the type A is superior to the type B in reducing the magnetic path length, and hence in miniaturization of the multiphase transformer.

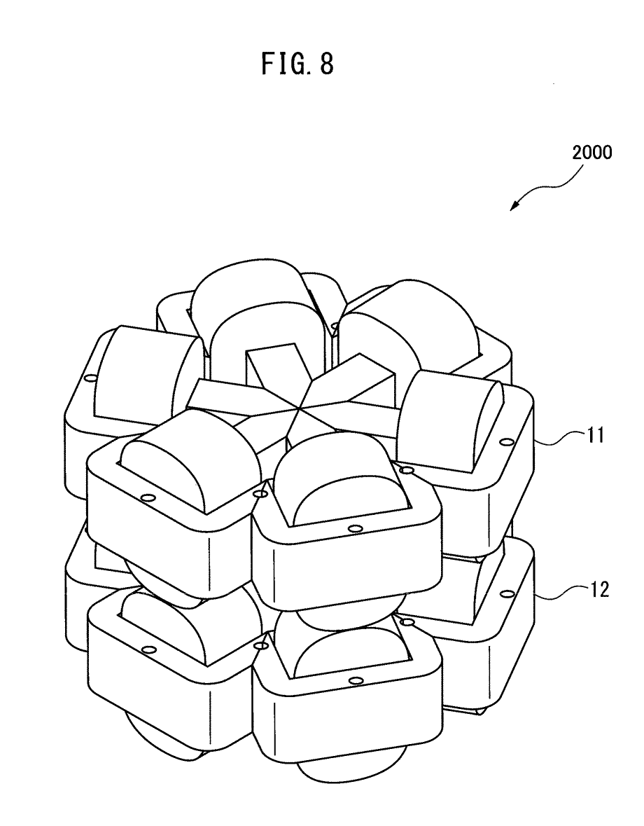

Then, a multiphase transformer according to a second embodiment will be described. FIG. 8 is a perspective view of the multiphase transformer according to the second embodiment. The difference between a multiphase transformer 2000 according to the second embodiment and the multiphase transformer 10 according to the first embodiment is that the multiphase transformer 2000 according to the second embodiment has two-layer structure in which two multiphase transformers 11 and 12 are connected in series and arranged in layers in a perpendicular direction. The other structure of the multiphase transformer according to the second embodiment is the same as that of the multiphase transformer according to the first embodiment, and therefore a detailed description is omitted.

According to the multiphase transformer of the second embodiment, since the two multiphase transformers 11 and 12 are arranged in layers in the perpendicular direction, the volume of the multiphase transformer can be increased without an increase in its installation area.

According to the multiphase transformers according to the present disclosure, it is possible to reduce the size and weight of the multiphase transformers as result of reductions in the number of turns of the coils.

1. A multiphase transformer comprising:
a peripheral iron core;
at least six leg iron cores arranged on an inner surface side of the peripheral iron core at established intervals in a circumferential direction; and
coils each wound on each of the at least six leg iron cores, wherein
each of the at least six leg iron cores is arranged such that one end in a direction of a winding axis of the coil is magnetically connected to the peripheral iron core, and the other end in the direction of the winding axis is magnetically connected to the other end of another leg iron core of the at least six leg iron cores, and
the at least six coils are assigned to individual phases of the multiphase transformer in twos or more.

2. The multiphase transformer according to claim 1, wherein the number of the at least six coils is an integral multiple of 3.

3. The multiphase transformer according to claim 1, wherein the number of the at least six coils is an integral multiple of 6.

4. The multiphase transformer according to claim 1, wherein two opposite coils with respect to a center of the peripheral iron core are assigned to the same phase.

5. The multiphase transformer according to claim 1, wherein one coil of the at least six coils is assigned to the same phase as another adjoining coil.
